(19) United States
(12) Patent Application Publication
(10) Pub. No.: US 2019/0008280 A1
(43) Pub. Date: Jan. 10, 2019

(54) Anchored Pilo for Head Support

(71) Applicant: Pradip Buch, Darien, IL (US)

(72) Inventor: Pradip Buch, Darien, IL (US)

(21) Appl. No.: 15/645,037

(22) Filed: Jul. 10, 2017

(51) Int. Cl. A47C 7/38; B60N 2/48; A47G 9/10; B64D 11/06

(52) U.S. Cl. CPC A47C 7/383; B64D 11/06; A47G 9/1081; B60N 2/4879

(57) ABSTRACT

Resting and napping in sitting position is often desired.

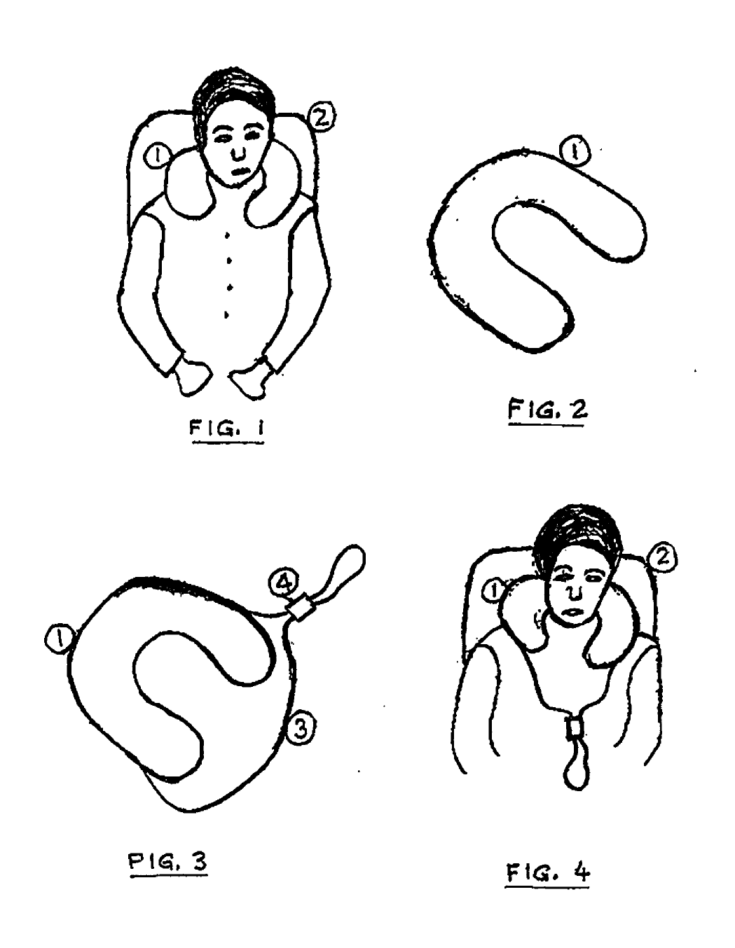

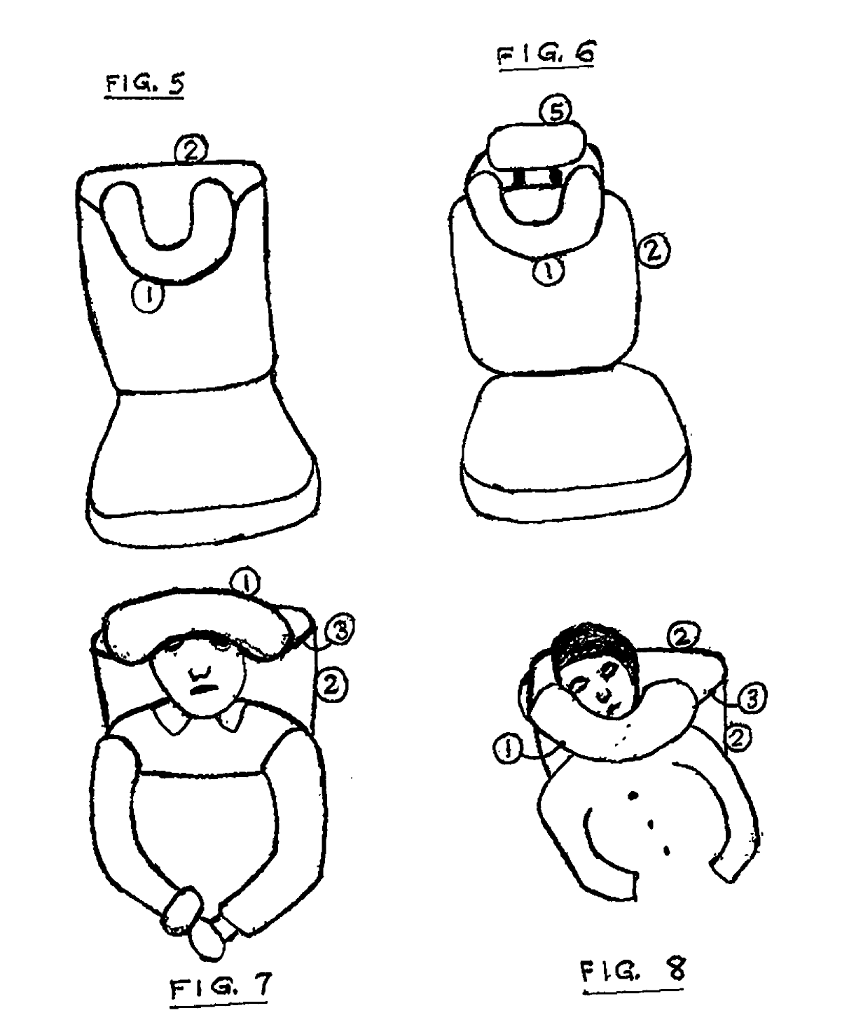

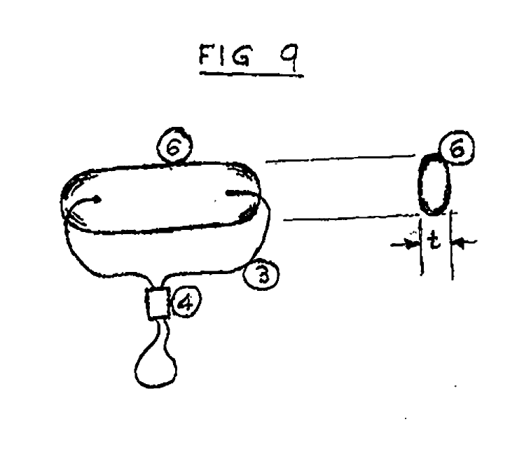

Neck Pillow, a Prior Art, is a U shaped Soft Surface, provides head support and thus helps napping.

Anchored Pilo improves the quality of the head support provided by Neck Pillow.

Anchored Pilo expands the use of Neck Pillow (and other Soft Surfaces) by anchoring it. An adjustable length Strap is used for anchoring. The Length adjustability makes Anchored Pilo usable for chairs and people of different dimensions. A Neck Pillow with Strap can still be used as Neck Pillow when the Strap is not used for anchoring.

### BACKGROUND

Resting or napping in sitting position, as in cars and planes, is desired. Reclining airline seats cause problems as they invade the small space of passengers in the back. Some airlines have made their seats non-reclinable, reducing passengers' comfort level. Higher reclining increases the floor space needed for the chair, and thus, accommodates fewer passengers. A seat cannot recline when a Knee Defender is used.

Neck Pillow, a Prior Art, is a U-shape Soft Surface, designed for the napping help, has been on market with many design variations, including inflatable versions.

### SUMMARY

Neck Pillow, a very old Prior Art, provides head support which helps napping.

It is not anchored.

This invention expands the use of Neck Pillow (and Soft Surfaces) by making it anchor-able. Anchoring improves head support against leans. An adjustable length Strap is used for anchoring.

### DETAILED DESCRIPTION

‘Pilo’ refers to Soft Surfaces of various shapes and thicknesses.

The figures, their description, and photos further explains this invention.

Neck Pillow supports head against leans in sitting position. When anchored, quality of the head support provided by the Neck Pillow improves. Length adjustability of Strap makes Anchored Pilo usable for chairs and people of different dimensions. Strap is located behind the seat at top, or behind the flaps in planes, or behind Head Rest in vehicles. The Strap is then tightened as needed for anchoring. Anchored Pilo then supports the head against leans. Figures clarify the use of Anchored Pilo. Photos are included to help understand the figures.

The use of Anchored Pilo in vehicle seats is very similar to the use shown in the sketches and photos.

### Competition

Head Support, Travel Neck Pillow, Passenger's Pillow, Relax ALLY, Taekwondo Helmet, Trapper's cap, Massaging Pillow, winter cap, winter coat with cap.

Some airline seats have Flaps which pop out to support head. Flaps do not support forward lean and side lean support is weak.

Passenger's Pillow does provide a good support against front lean only. It requires inflating and deflating. Since the Pillow rests on the meal tray, it blocks the side passengers' access to aisle.

1. Neck Pillow is a Prior Art to support the head in sitting position.
I claim the ownership of:
1. Anchored Pilo, made using Neck Pillow.
2. Anchored Pilo, made using other shaped Soft Surfaces.
3. Anchored Pilo integrated in a seat design.
